(19) United States
(12) Patent Application Publication
(10) Pub. No.: US 2016/0318208 A1
(43) Pub. Date: Nov. 3, 2016

(54) Concrete Pole Mould and Manufacturing Method Therefor Using Centrifugal Force with Exchangeable Inner Moulds

(71) Applicants: HEE SUN YOON, Seongnam-si Kyungki-do (KR); MYUNG SECK LIM, Euijungbu-si Kyungki-do (KR)

(72) Inventors: HEE SUN YOON, Seongnam-si Kyungki-do (KR); MYUNG SECK LIM, Euijungbu-si Kyungki-do (KR)

(21) Appl. No.: 15/005,008

(22) Filed: Jan. 25, 2016

(30) Foreign Application Priority Data
Jan. 26, 2015 (KR) 10-2015-0012163

(51) Int. Cl. B28B 17/00; B28B 7/00; E04C 3/34; B28B 1/20

(52) U.S. Cl. CPC B28B 17/009; B28B 1/20; B28B 7/0064; B28B 7/0082; E04C 3/34

(57) ABSTRACT

A method for forming concrete poles using centrifugal force comprises steps of positioning first and second inner moulds into first and second outer moulds, wherein a decoration and function shaping part is detachably attached on the inner circumference of each of the first and second inner moulds, assembling the first and second outer moulds with the first and second inner moulds, wherein the assembled first and second outer moulds and first and second inner moulds constitute a concrete pole mould, pouring concrete into inside of the concrete pole mould, rotating the concrete pole mould at high speed, and disassembling the first and second inner moulds from the first and second outer moulds. The mould device for performing the method and the concreted pole made by the method are also provided.

### CROSS-REFERENCE TO RELATED APPLICATIONS

This application claims priority based on Korean Patent Application No. 10-2015-0012163 filed on Jan. 26, 2015, the disclosure of which is incorporated by reference as if it is set forth herein.

### FIELD OF THE INVENTION

The present invention is related to a concrete pole mould device that enables forming an external part having various shapes and functions on the external peripheral surface of a pole made of concrete, a method of manufacturing concrete poles with the mould device, and the manufactured concrete poles.

### DESCRIPTION OF THE PRIOR ART

In general, roadside facility poles fixed installed on the ground and operated at dark roads, or sidewalks include street lamps that facilitate safe movement of pedestrians by illuminating their field of vision, traffic lights that securely guide passage of pedestrians and vehicles on the roads, bollards that prevent cars from entering into specific area like sidewalks, and utility poles that provide electricity to homes or offices.

Metals have widely been used to make the above-explained prior art roadside facilities utilizing the good formability of metals.

However, the recent trend for building and civil engineering is that nature-friendly effect is pursued by designing buildings and civil engineering structures to be built using materials that are harmonized with nature. In this context, poles for roadside facilities are formed with concrete to obtain more nature-friendly effect than metal materials, and outer circumferential surfaces are ground to obtain rock appearance, etc. Use of metal materials are restrained because they give hard and cold feelings; painting work may cause respiratory or brain diseases; and corrosion or breakage problems occur due to prolonged exposure to snow or rain thereby generating substantial maintenance cost.

Prior art for said conventional mould device that forms roadside facility poles of concrete material includes Korean Patent Application Publication No. 2013-0092828 (title: the centrifugal type mold for manufacturing the straight type and extensible concrete pile) and Korean Patent No. 1358754 (title: Pillar for the Road Equipment) by the Applicants.

The above prior arts are introduced to help understanding of the present invention and only exemplary. According to the prior art, poles are formed with centrifugal force by rotating a mould, in which concrete materials are poured, at high speed, dried and the winded to provide the finished product.

The outer circumference of the prior art concrete pole made in this way is plain and simple because it is formed without a particular shape at the mould. Therefore as shown on FIG. 1, in order to be harmonized with the location at which the pole is installed, a protective cover plate (201) with special appearances printed on it or a protective cover having many triangular sharp protrusions that facilitate removing attachments was wrapped around and fixed to the outer circumference of a concrete pole (200).

However, when such protective cover (201) of metal material is installed around a concrete pole (200), the above-mentioned problems of metal poles are not solved but manifested as they are. Further, because a metal part is fixed to a concrete part, the resulting heterogeneity prevents the pole from being harmonized with the surrounding structures. Even further, the protective cover (201) made of synthetic or metal material and having many protrusions requires a separate mould, which causes more production cost and slower production speed.

Therefore, outer circumference shapes for concrete pole requested by consumer, local government and the installation location could not be formed directly from a mould. Even though a special shape was formed on the inner surface of a mould device, such high cost mould device was not suitable for mass production.

### SUMMARY OF THE INVENTION

An objective of the invention is to provide a mould device for forming concrete poles that facilitate exchange of moulds for forming various appearances of the moulded poles.

Another objective of the invention is to provide a method for forming concrete poles that facilitate exchange of moulds for forming various appearances of the moulded poles.

In order to achieve the objectives, the present invention provides a mould device for forming concrete poles using centrifugal force, wherein concrete poured inside the mould device, and the mould device is rotated at high speed, comprising a first outer mould and a second outer mould that have hollow inside and semi-circular shape, wherein each of the first outer mould and the second outer mould comprises an engaging jaw that is formed longitudinally along the length of each of the two separating ends of the first outer mould and second outer mould, a plurality of engaging holes formed on the engaging jaw, wherein the first outer mold and the second outer mould are assembled with bolts passing through the engaging holes, a first inner mould and a second inner mould that have hollow inside and semi-circular shape, wherein the first and second inner moulds are received inside of the first and second outer moulds, respectively; wherein a decoration and function shaping part is detachably attached on the inner circumference of each of the first and second inner moulds; wherein the decoration and function shaping parts are adapted to form a decoration and function part on the outer circumference of a concrete pole moulded by the mould device; and a mould fixing and release device that fixes the first and second inner moulds inside the first and second outer moulds in the process of preparing moulding of the concrete pole, and releases the first and second inner moulds from the first and second outer moulds after moulding is complete.

In an embodiment, the mould fixing and releasing device comprises one or more through slots formed on each of the first and second outer moulds extending along the circumference of the circle viewed from side when the first and second outer moulds are assembled, threaded rods formed on the outer circumferences of the first and second inner moulds at positions corresponding to the through slots and protrude a length that pass beyond the through slots, and nuts engaging with threaded rods.

In another embodiment, the mould fixing and release device comprises through slots formed on each of the first and second outer moulds extending along the circumference of the circle viewed from side when the first and second outer moulds are assembled, and bent assembly rods formed on the outer circumferences of the first and second inner moulds at positions corresponding to the through slots, wherein the bent assembly rods are bent in L shape and reversed L shape to have a knock portion at its end and a fixing groove surrounded by the bent portion, wherein the bent assembly rods pass through the through slots, wherein the through slot is formed longer than the size of the end of the bent assembly rod to enable passing of the bent assembly rod.

The decoration and function shaping part comprises engraved and embossed parts, the shape of which comprise lattice, elongated longitudinal grooves, rings, irregular forms, or geometrical figures.

The first and second inner moulds may comprise a plurality of inner mould segments that divide the inner moulds longitudinally or horizontally, and end inner mould segments; wherein each of the inner mould segments comprises a first engaging jaw formed on its one end, wherein the first engaging jaw has a protrusion, the surface of which directs upward with reference to the centerline of the side of the segment, and a second engaging jaw formed on its other end, the surface of which directs downward with reference to the centerline of the side of the segment, and thereby the first engaging jaw and the second engaging jaw correspond with each other, wherein the plurality of the inner mould segments are received inside the first and second outer moulds with their first engaging jaws and second engaging jaws engaged with each other in series; and wherein the end inner mould segments comprise first, second engaging jaws that correspond to the first, second engaging jaws of the inner mould segments located far outside among the plurality of the inner mould segments received in the first and second outer moulds.

The engaging jaws provided at the two sides of the first outer mould comprise engaging grooves, and the corresponding engaging jaws of the second outer mould comprise engaging protrusions, which are received in the engaging grooves, wherein a sealing ring is provided in the engaging groove and compressed by the engaging protrusion.

The access opening forming part of a predetermined size is provided longitudinally on the inner circumference of either of the first and second inner moulds thereby installing an access opening in the concrete pole.

The present invention provides a method of forming concrete poles using centrifugal force comprising steps of: positioning first and second inner moulds into first and second outer moulds; wherein the first outer mould and the second outer mould have hollow inside and semi-circular shape, wherein each of the first outer mould and the second outer mould comprises an engaging jaw that is formed longitudinally along the length of each of the two separating ends of the first outer mould and second outer mould, a plurality of engaging boles formed on the engaging jaw, wherein the first outer mold and the second outer mould are assembled with bolts passing through the engaging holes; wherein the first inner mould and the second inner mould have hollow inside and semi-circular shape, wherein the first and second inner moulds are received inside of the first and second outer moulds, respectively; wherein a decoration and function shaping part is detachably attached on the inner circumference of each of the first and second inner moulds; wherein the decoration and function shaping parts are adapted to form a decoration and function part on the outer circumference of a concrete pole moulded by the mould device; and assembling the first and second outer moulds with the first and second inner moulds, wherein the assembled first and second outer moulds and first and second inner moulds constitute a concrete pole mould; pouring concrete into inside of the concrete pole mould; rotating the concrete pole mould; and disassembling the first and second inner moulds from the first and second outer moulds.

In an embodiment, the mould fixing and release device comprises through slots formed on each of the first and second outer moulds extending along the circumference of the circle viewed from side when the first and second outer moulds are assembled, and bent assembly rods formed on the outer circumferences of the first and second inner moulds at positions corresponding to the through slots, wherein the bent assembly rods are bent in L shape and reversed L shape to have a knock portion at its end and a fixing groove surrounded by the bent portion, wherein the bent assembly rods pass through the through slots, wherein the through slot is formed longer than the size of the end of the bent assembly rod to enable passing of the bent assembly rod; wherein at the step of rotating the concrete pole mould, initially the first and second outer moulds are rotated but the first and second inner moulds, which have not been fixed to the first and second outer moulds yet, are not rotated, and then one end of the rotating through slot is inserted into the fixing groove of the bent assembly rod thereby being fixed to it, and then further rotation of the first and second outer moulds rotates the first and second inner moulds. At the step of disassembling the first and second inner moulds from the first and second outer moulds, the knock portion of the bent assembly rod is hit in the reverse rotation direction with a hitting tool to cause movement of the bent assembly rod in the through slot thereby causing movement of the first and second inner moulds from which the bent assembly rods protrude.

In another embodiment, the mould fixing and release device comprises one or more through slots formed on each of the first and second outer moulds extending along the circumference of the circle viewed from side when the first and second outer moulds are assembled; a threaded rod formed on the outer circumference of the first inner mould at a position corresponding to the through slot and protrudes a length that passes beyond the through slot; a nut engaging with the threaded rod; and a bent assembly rod formed on the outer circumference of the second inner mould at a position corresponding to the through slot: wherein the bent assembly rod is bent in L shape to have a knock portion at its end and a fixing groove surrounded by the bent portion, wherein the bent assembly rod passes through the through slot, which is formed longer than the size of the end of the bent assembly rod to enable passing of the bent assembly rod; wherein at the step of rotating the concrete pole mould, the first and second outer moulds start to rotate while the first and second inner moulds remain stationary thereby causing one end of the through slot formed on the second outer mould to be inserted and fixed into the fixing groove of the bent assembly rod. At the step of disassembling the first and second inner moulds from the first and second outer moulds, the knock portion of the bent assembly rod formed on the second inner mould is hit in the reverse rotation direction with a hitting tool to cause movement of the bent assembly rod in the through slot thereby causing movement of the second inner mould along the through slot.

The present invention also provides a concrete pole made by the above-explained method.

The advantageous effects of the present invention are: (1) desired patterns are integrally moulded on the outer circumference of a concrete pole providing superior aesthetic effect that is harmonized with the surroundings; (2) only the inner moulds need to be exchanged to manufacture concrete poles having different decorations or functions thereby lowering manufacturing cost and enhancing manufacturing speed; (3) the inner moulds can be prepared as various shapes in response to demands of consumers or local governments; (4) productivity is substantially increased with the easily exchangeable inner moulds; (5) the concrete poles have minimal contact area exposed thereby preventing attachment of unwanted advertising material; (6) the inner moulds are automatically engaged with the outer moulds by the outer moulds' rotation thereby reducing assembling time; (5) cured concrete permeated between the outer moulds and the inner moulds can be easily broken and removed by hitting the mould fixing and releasing device; (5) additional grinding or shot blasting provide natural rock appearance by exposing stone chips in the concrete.

### BRIEF DESCRIPTION OF THE DRAWINGS

In the drawings:

FIG. 1 is a photograph showing a concrete pole with a protective cover by prior art;

FIGS. 2(A) and 2(B) are exploded perspective views showing first and second outer moulds and first and second inner moulds according to the present invention;

FIG. 3(A) is a longitudinal cross-sectional view showing a mould device according to the present invention;

FIG. 3(B) is a partial enlarged cross-sectional view showing a decoration and function shaping part;

FIGS. 4(A) and 4(B) are exploded horizontal cross-sectional views showing the mould device with mould fixing and removing means according to the first embodiment of the present invention;

FIG. 5 is a perspective view showing assembled state of the parts in FIGS. 4(A) and 4(B);

FIG. 6 a perspective view showing the mould device with mould fixing and removing means according to the second embodiment of the present invention;

FIG. 7(A) is a horizontal cross-sectional view of the device in FIG. 6;

FIG. 7(B) is a partial and enlarged cross-sectional view showing a mould fixing and release device;

FIG. 8 is a perspective view showing the mould device with mould fixing and removing means according to the third embodiment of the present invention;

FIGS. 9(A) and 9(B) are exploded horizontal cross-sectional views of the mould device in FIG. 8;

FIGS. 10(A) and 10(B) are horizontal cross-sectional views of the mould fixing and removing means of the third embodiment in fixed state;

FIGS. 10(C) and 10(D) are partial and enlarged cross-sectional views showing mould fixing and release devices;

FIG. 11(a) is a perspective view showing an upper part of mould fixing and removing means according to the fourth embodiment of the present invention;

FIG. 11(b) is a perspective view showing a lower part of the means;

FIG. 12 is a longitudinal cross-sectional view showing that the first and second inner moulds are separated;

FIG. 13(A) is a horizontal cross-sectional view showing the first and second outer moulds with receiving recess and receiving protrusion formed thereon and a water-tight ring

FIG. 13(B) is a partial enlarged cross-sectional view showing an engaging structure;

FIG. 14 is a longitudinal cross-sectional view of the mould device with the first or second inner mould on which an access opening is formed;

FIG. 15 is an elevation view showing a concrete pole formed with the mould device of the present invention;

FIG. 16 is a partial enlarged longitudinal cross-sectional view showing protrusions on a decoration and function part;

FIG. 17 is a photograph showing a concrete pole formed with the mould device of the present invention;

FIG. 18 is a photograph showing other concrete poles formed with the mould device of the present invention; and

FIG. 19 is a flow diagram showing a method for forming concrete poles according to the present invention.

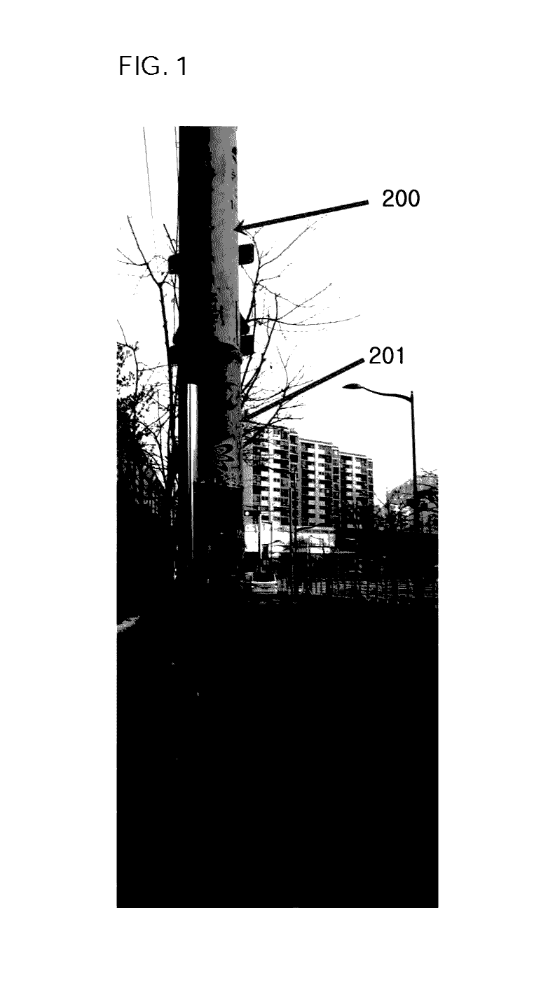

### DESCRIPTION OF PREFERRED EMBODIMENTS

Preferred embodiments of the present invention are explained in detail below referring to attached drawings.

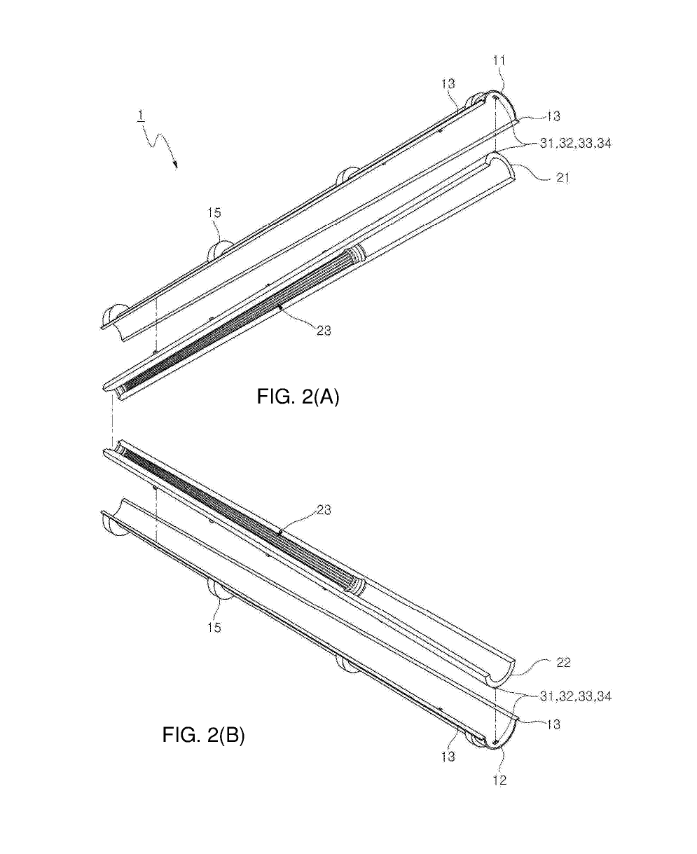

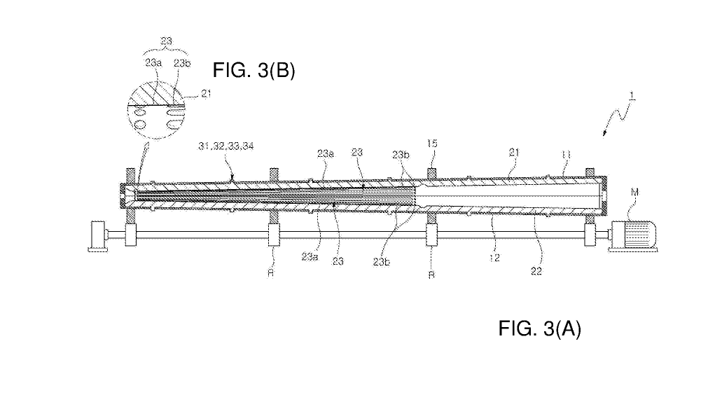

FIGS. 2(A), 2(B), 3(A) and 3(B) show that a mould device (1), by which a concrete pole (100) is formed, comprises a first outer mould (11), a second outer mould (12); a first inner mould (21) and a second inner mould (22), wherein the first and second inner moulds are received inside of the first and second outer moulds, respectively, and a decoration and function shaping part (23) of various shapes is formed on the inner circumference of the first and second inner moulds; and a mould fixing and release device (31)(32)(33)(34) that enables fixing the first and second inner moulds inside the first and second outer moulds in the process of preparing moulding of the concrete pole (100), and releasing them after moulding is complete.

In particular, as the decoration and function shaping parts (23) of the first and second inner moulds (21)(22) finish the moulding, a decoration and function part (101) of various shape is formed on the surface of the concrete pole (100).

The concrete pole (100) may include road side facilities such as street lamp poles, utility poles, traffic light poles., and bollards, etc. that are erected and operated on roads. The mould device (1) is designed and constructed according to necessary size and length of the roadside facilities.

As shown on FIGS. 2(A), 2(B), 3(A), 3(B), 4(A) and 4(B), the first and second outer moulds (11)(12) have hollow inside; have semi-circular column shape; comprises an engaging jaw (13) that is formed longitudinally along the length of each of the two separating ends of the first and second outer moulds (11)(12), a plurality of engaging holes (14) formed on the engaging jaw (13), and ribs (15) formed on its outer circumference with predetermined intervals having diameter lamer than the outer diameter of the first and second outer moulds (11)(12). With this construction, when a motor (M) is rotated at high speed to form a concrete pole (100), the first and second outer moulds (11)(12) are rotated with the ribs (15) are stably supported by rollers (R).

Like the first and second outer moulds (11)(12), the first and second inner moulds (21)(22) have hollow inside, have semi-circular column shape; comprise a decoration and function shaping parts (23) of engraved and embossed part (23b) or of arbitrary shape formed on the entire or a certain part of the inner circumference of the inner moulds in regular pattern or in irregular pattern. The decoration and function shaping part (23) forms the various decoration and function part (101) on the outer circumference (101a) of the concrete pole (100). The first and second inner moulds (21)(22) are received in the first and second outer moulds (11)(12) respectively.

The shape of the decoration and function shaping part (23) may have convex circular shape with concave slots on the outer circumference of the concrete pole (100); or convex, concave or helix shape on the entire outer circumference; or letters or designs for emblems that represent local government or installation location, which may be formed on the concrete pole (100). With this construction, a protective cover (201) is not required, which is made by rolling a plate having certain shapes formed on it and fixed to the pole, and a concrete pole (100) integrally made with concrete only is provided.

Materials for the first and second inner moulds (21)(22) include metal (aluminum), non-metallic materials like synthetic resin (FRP), carbon fiber or silicone, which have good formability Also, the moulds may be made of materials suitable for forming by 3-D printers such as filament type solid material, photo curing resin type liquid material, fine plastic powder, sand, and metal powder.

The mould fixing and release device (31)(32)(33)(34) are constructed to enable easy and fast attaching, detaching and exchanging the first and second inner moulds (21)(22) to the first and second outer moulds (11)(12). The present invention provides four embodiments.

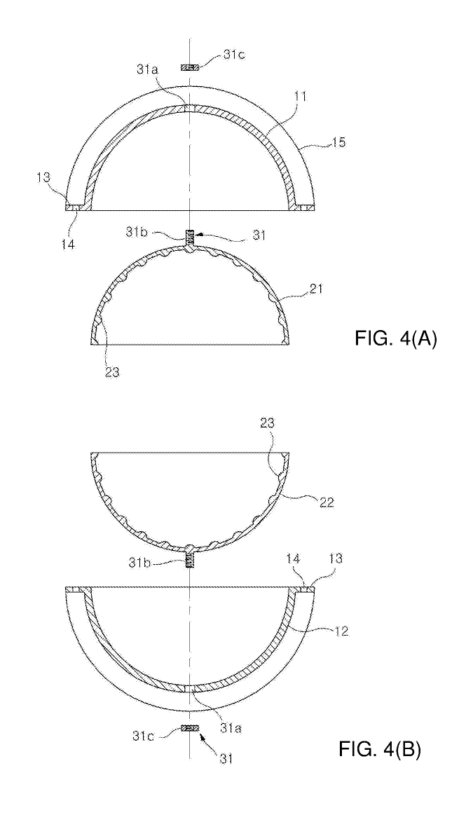

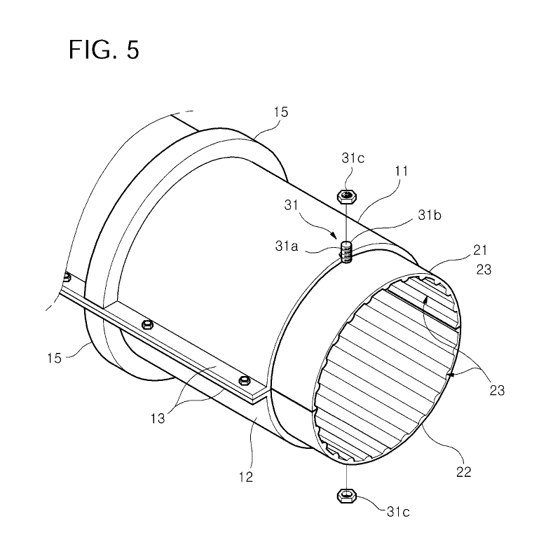

In the first embodiment shown on FIGS. 4(A), 4(B) and 5, the mould fixing and release device (31) comprises through hole(s) (31a) that are formed on each of the first and second outer moulds (11)(12), wherein the through hole(s) (31a) are provided as single or plurality with predetermined interval along the length of the first and second outer moulds (11)(12); and threaded rod(s)(31b) that protrude a length that can pass beyond the through hole (31a) from the outer circumferences of the first and second inner moulds (11)(12) at positions corresponding to the through holes (31a). Nuts (31c) engage threaded portions formed on the outer circumferences of the threaded rods (31b) that protrude beyond the through holes (31a) so that the first and second outer moulds (11)(12) and the first and second inner moulds (21)(22) are firmly fixed to each other.

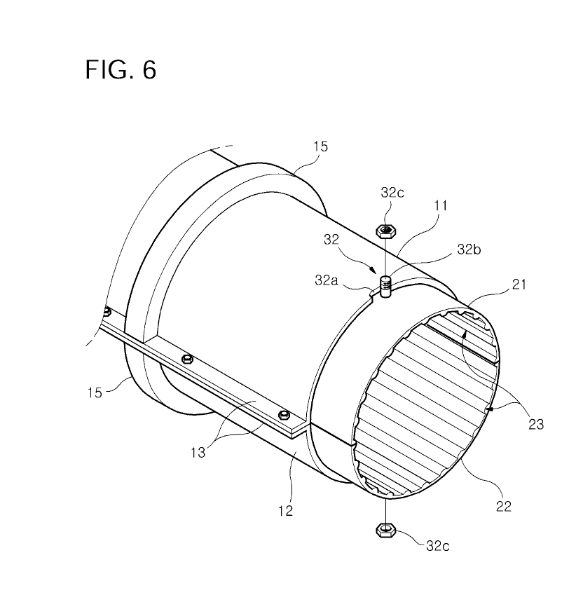

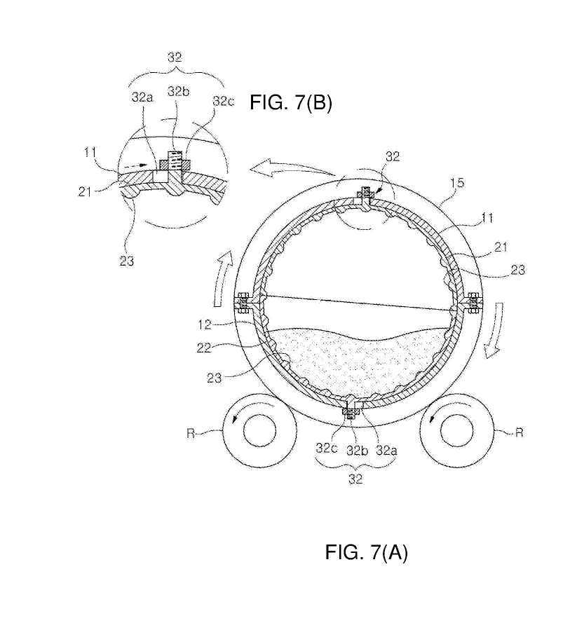

In the second embodiment shown on FIGS. 6, 7(A) and 7(B), the mould fixing and release device (32) comprises through slot(s) (32a) formed on each of the first and second outer moulds (11)(12) extending along the circumference of the circle viewed from side when the first and second outer moulds (11)(12) are assembled. The through slots (32a) are provided as single or plurality with predetermined interval along the length of the first and second outer moulds (11)(12).

Threaded rods (32b) are formed on the outer circumferences of the first and second inner moulds (21)(22) at positions corresponding to the through slots (32a) and protrude a length that pass beyond the through slots (32a). A threaded portion, which is formed on the outer circumference of the portion that passes beyond the through slot (32a), engage with a nut(32c).

The threaded rods (32b) pass through the through slots (32a) of the first and second outer moulds (11)(12) and the nuts (32c) engage the threaded rods (32b) with the first and second inner moulds (21)(22) being received in the first and second outer moulds (11)(12) so that rotation of the first and second inner moulds (21)(22) relative to the first and second outer moulds (11)(12) is possible.

The reason of enabling this rotation is that when the concrete pole (100) is formed, concrete material permeated into gaps between the first and second inner moulds (21)(22) and the first and second outer moulds (11)(12) may be hardened, and in this case, if the nut (32c) is hit by a tool, the threaded rod (32b) is guided to the direction opposite to the hit within the through slot (32a) thereby breaking the hardened concrete in the gap to facilitate exchange of the first and second inner moulds (21)(22).

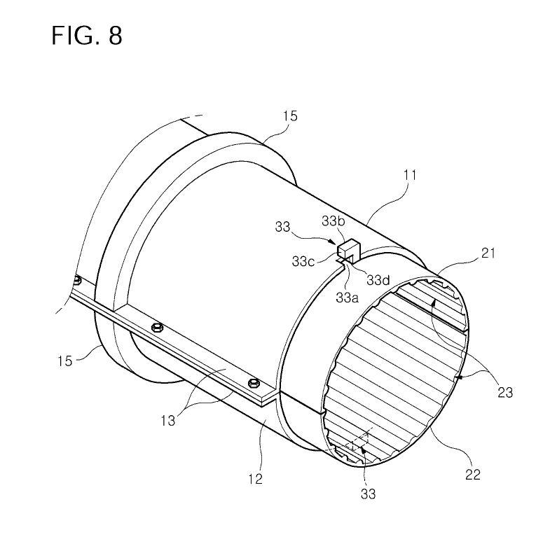

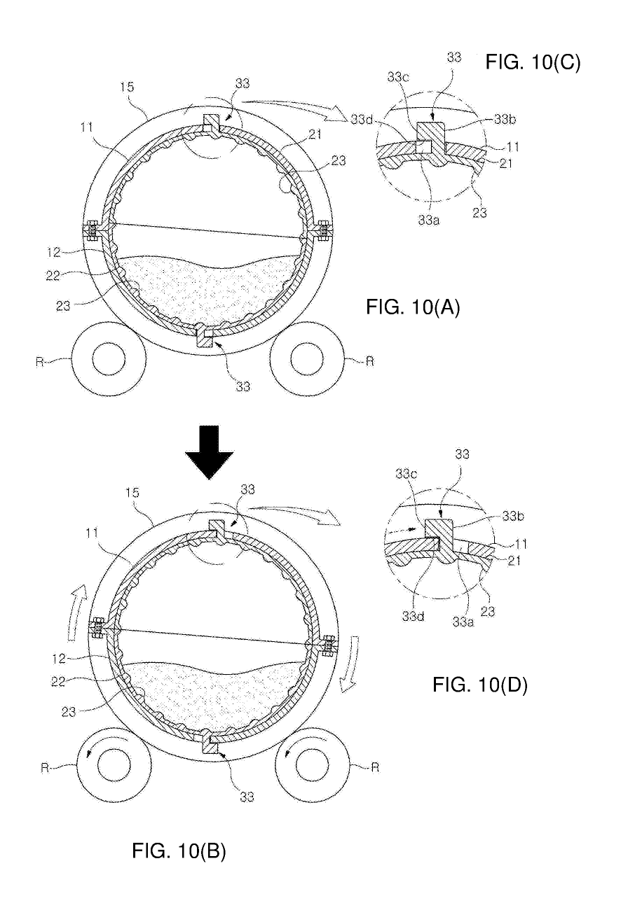

In the third embodiment shown on FIGS. 8, 9(A), 9(B), 10(A), 10(B), 10(C) and 10(D), the mould fixing and release device (33) comprises through slot(s)(33a) formed on each of the first and second outer moulds (11)(12) extending along the circumference of the circle viewed from side when the first and second outer moulds (11)(12) are assembled. The through slots (33a) are provided as single or plurality with predetermined interval along the length of the first and second outer moulds (11)(12).

Bent assembly rods (33b) are formed on the outer circumferences of the first and second inner moulds (21)(22) at positions corresponding to the through slots (33a). The bent assembly rod (33b) is bent in L shape and reversed L shape to have a knock portion (33c) at its end and a fixing groove (33d) surrounded by the bent portion. The bent assembly rod (33b) pass through the through slot (33a).

Therefore, the through slot (33a) is formed longer than the size of the end of the bent assembly rod (33b) to enable passing of the bent assembly rod (33b).

With the construction of L shape and reversed L shape bent assembly rod (33b), when the mould device (1) is rotated at high speed by the motor (M) and the rollers (R) to mould the concrete pole (100), initially the first and second outer moulds (11)(12) are rotated but in a state, in which the first and second inner moulds (21)(22), which have not been fixed to the first and second outer moulds (11)(12) yet, are not rotated, one end of the rotating through slot (33a) is inserted into the fixing groove (33d) of the bent assembly rod (33b) thereby being fixed to it, and then further rotation of the first and second outer moulds (11)(12) rotates the first and second inner moulds (21)(22) so that the moulding process is performed.

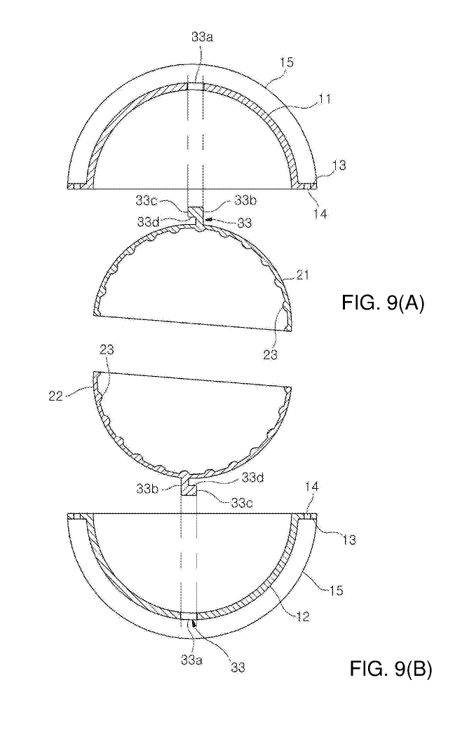

As shown on FIGS. 9(A) and 9(B), when the first and second outer moulds (11)(12) are rotated clockwise by the motor (M), the bent assembly rod (33b) is shaped reversed L for the outer circumference of the first outer mould (11), and shaped L for the outer circumference of the second outer mould (12) thereby enabling the through slot (33a) is fixed into the fixing groove (33d) as it is rotated. When the rotation direction is counterclockwise, the bent direction is reversed.

Repeated moulding of concrete poles (100) with the same decoration and function part (101) for prolonged period, concrete permeated between the first and second outer moulds (11)(12) and the first and second inner moulds (21)(22) are cured and hardened thereby making change to the first and second inner moulds (21)(22) difficult.

At this situation, hitting the knock portion (33c) of the bent assembly rod (33b) in the reverse rotation direction with a hitting tool causes movement of the bent assembly rod (33b) in the through slot (33a) thereby causing movement of the first and second inner moulds (21)(22) from which the bent assembly rods(33b) protrude, thereby cracking the hardened concrete to enable disassembly and removing of the inner moulds.

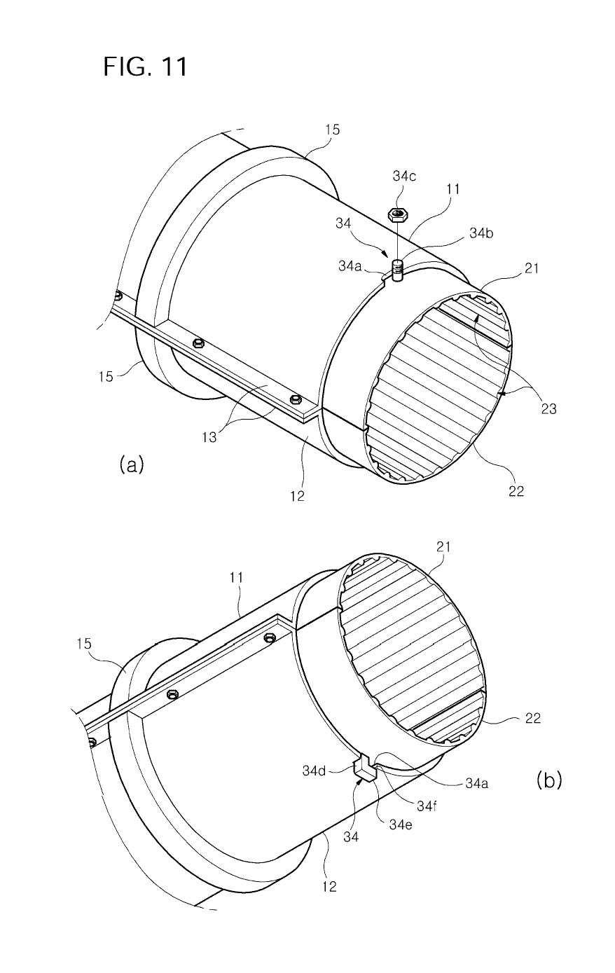

In the fourth embodiment shown on FIG. 11, the mould fixing and release device (34) comprises through slot(s)(34a) formed on each of the first and second outer moulds (11)(12) extending along the circumference of the circle viewed from side when the first and second outer moulds (11)(12) are assembled. The through slots (34a) are provided as single or plurality with predetermined interval along the length of the first and second outer moulds (11)(12).

A threaded rod (34b) is formed on the outer circumference of the first inner mould (21) at a position corresponding to the through slot (34a) and protrudes a length that passes beyond the through slot (34a). A threaded portion of the threaded rod, which is formed on the outer circumference of the portion that passes beyond the through slot(34a), engages with a nut(34c). The threaded rod (34b) can move along the through slot (34a) with the nut(34c) engaged with the threaded portion.

A bent assembly rod (34d) is formed on the outer circumference of the second inner mould (22) at a position corresponding to the through slot (34a) formed at the other location. The bent assembly rod (34d) is bent in L shape to have a knock portion (34e) at its end and a fixing groove (34f) surrounded by the bent portion. The bent assembly rod (34d) passes through the through slot (34a), which is formed longer than the size of the end of the bent assembly rod (34d) to enable passing of the bent assembly rod (34d).

With this construction of the mould fixing and release device (34), because the first inner mould (21) is assembled to the first outer mould (11) by the nut (34c), when the first outer mould (11) is lifted with a hoist during moulding preparation, the nut (34c) engaged over the through slot (34a) prevents the first inner mould (21) from being separated thereby facilitating assembly with the second outer mould (12).

In addition, when the mould device (1) is assembled, the first inner mould (21), which is positioned above, is assembled with the engaged nut (34c) which prevents separation, and then when the mould device (1) is rotated, the first and second outer moulds (11)(12) start to rotate while the first and second inner moulds (21)(22) remain stationary thereby causing one end of the through slot (34a) formed on the second outer mould (12) to be inserted and fixed into the fixing groove (34f) of the bent assembly rod (34d). In this way, the moulds are rotated together and the moulding is performed.

Repeated moulding of concrete poles (100) with the same decoration and function part (101) for prolonged period, concrete permeated between the first and second outer moulds (11)(12) and the first and second inner moulds (21)(22) are cured and hardened thereby exchanging to the first and second inner moulds (21)(22) having different shapes difficult. At this situation, hitting the knock portion (34e) of the bent assembly rod (34d) formed on the second inner mould (22) in the reverse rotation direction with a hitting tool causes movement of the bent assembly rod (33b) in the through slot (33a) thereby causing movement of the second inner mould (22) along the through slot (34a), thereby causing the threaded rod (34b) of the first inner mould (21) that contacts the second inner mould (22) at the surfaces of its both ends moves along the through slot (34a), thereby cracking the hardened concrete to enable disassembly and removing of the inner moulds.

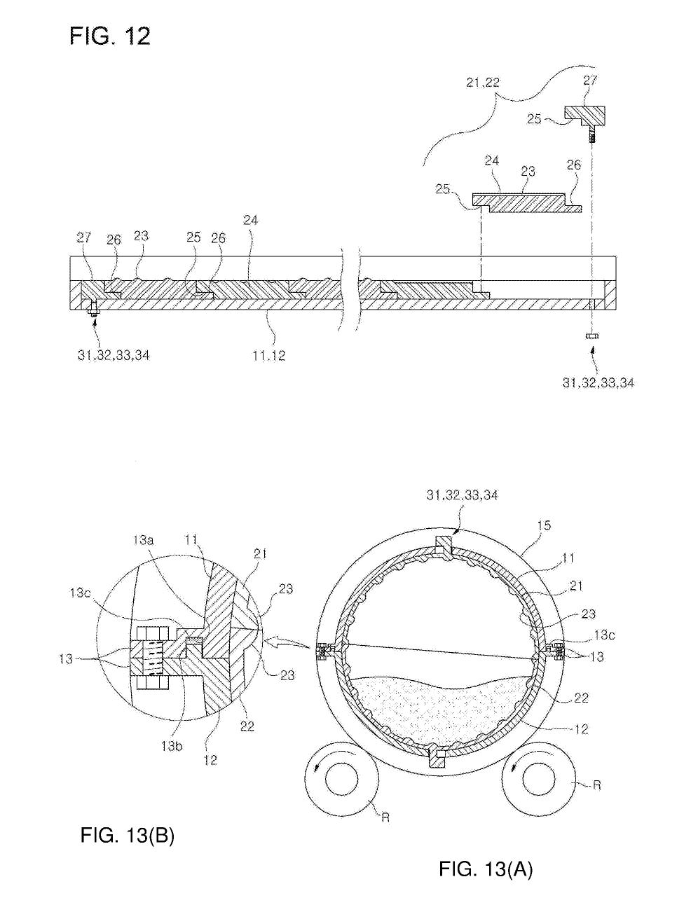

As shown on FIG. 12, the first and second inner moulds (21)(22) may be made as a single long body, and the decoration and function shaping part (23) is formed on the entire length, or to facilitate constructing the decoration and function shaping parts (23), plural inner moulds (21)(22) may be constructed.

If the inner moulds are divided, the first and second inner moulds (21)(22) comprise a plurality of inner mould segments (24) that divide the inner moulds longitudinally or horizontally The inner mould segment (24) comprises a first engaging jaw (25) formed on its one end, wherein the first engaging jaw (25) has a protrusion, the surface of which directs upward with reference to the centerline of the side of the segment, and a second engaging jaw (26) formed on it other end, wherein the second engaging jaw (26), the surface of which directs downward with reference to the centerline of the side of the segment, and thereby the first engaging jaw and the second engaging jaw correspond with each other. The plurality of the inner mould segments are received inside the first and second outer moulds (11)(12) with their first engaging jaws (25) and second engaging jaws (26) engaged with each other in series.

Further provided are end inner mould segments (27) that comprise first, second engaging jaw (25)(26) that correspond to the first, second engaging jaw (25)(26) of the inner mould segments located far outside among the plurality of the inner mould segments received in the first and second outer moulds (11)(12). The end inner mould segments (27) are fixed to the first, second outer moulds (11)(12) with the mould fixing and release device (31)(32)(33)(34) thereby the plurality of the inner mould segments (24) are fixed without separate fixing means thereby reducing installation work of the first and second inner moulds (21)(22).

As shown on FIGS. 13(A) and 13(B), the engaging jaws (13) provided at the two sides of the first outer mould (11) comprise engaging grooves (13a), and the corresponding engaging jaws (13) of the second outer mould (12) comprise engaging protrusions (13b), which are received in the engaging grooves (13a). With this construction, the first and second outer moulds (11)(12) are assembled at precise position, and in turn, the first and second inner moulds (21)(22), which are received inside the first and second outer moulds (11)(12), abut each other at precise positions, thereby aligning the decoration and function shaping part (23) correctly, which substantially reduces defect rate.

In addition, a sealing ring (13c) is provided in the engaging groove (13a) and compressed by the engaging protrusion (13b), which prevents water leak during the concrete pole (100) is moulded with centrifugal force.

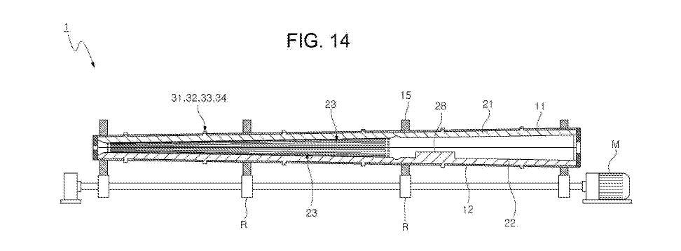

As shown on FIG. 14, an access opening forming part (28) of a predetermined size is provided longitudinally on the inner circumference of either of the first and second inner moulds (21)(22) to install an access opening that allows access of inside electrical device of a street lamp pole, etc.

With this construction of the mould device (1), manufacturing time is reduced because the first, second inner moulds (21)(22) are firmly fixed with the mould fixing and release device (31)(32)(33)(34), or automatically fixed by the rotating first, second outer moulds (11)(12). Also, when it is difficult to disassemble the first and second inner moulds (21)(22) due to hardened concrete, the moulds are rotated by striking the mould fixing and release device (31)(32)(33)(34) by hitting tool thereby breaking the hardened concrete.

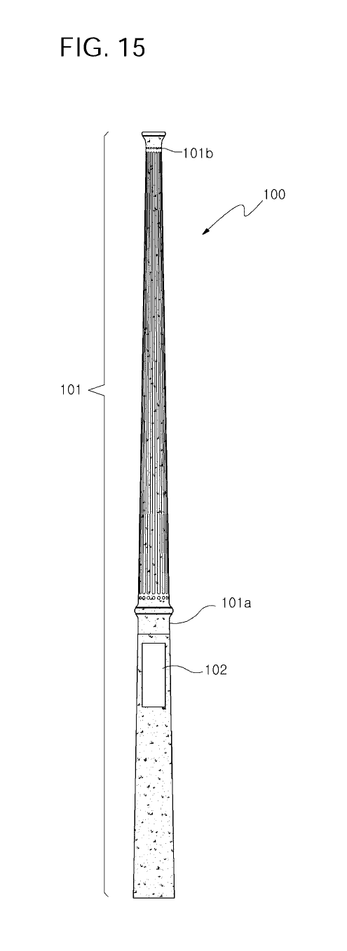

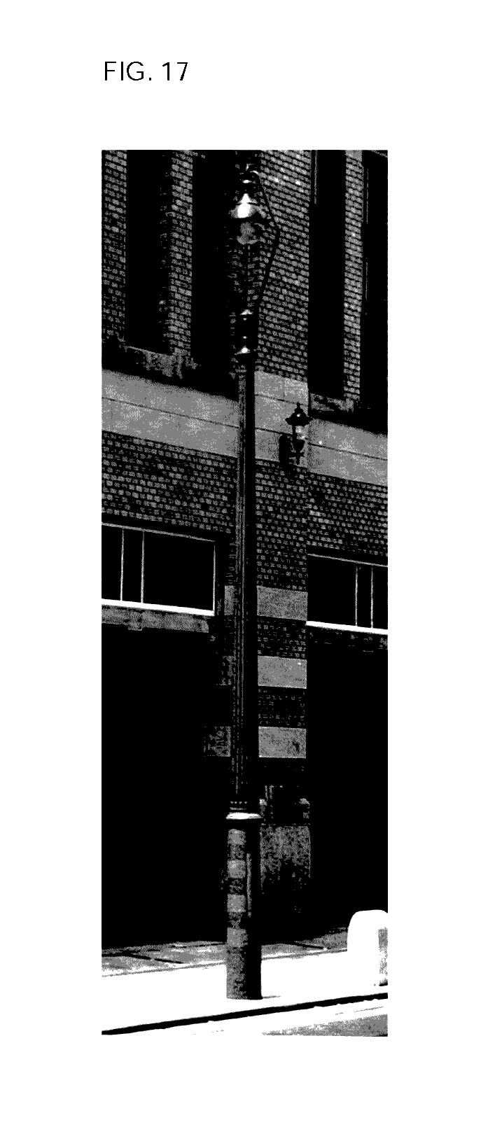

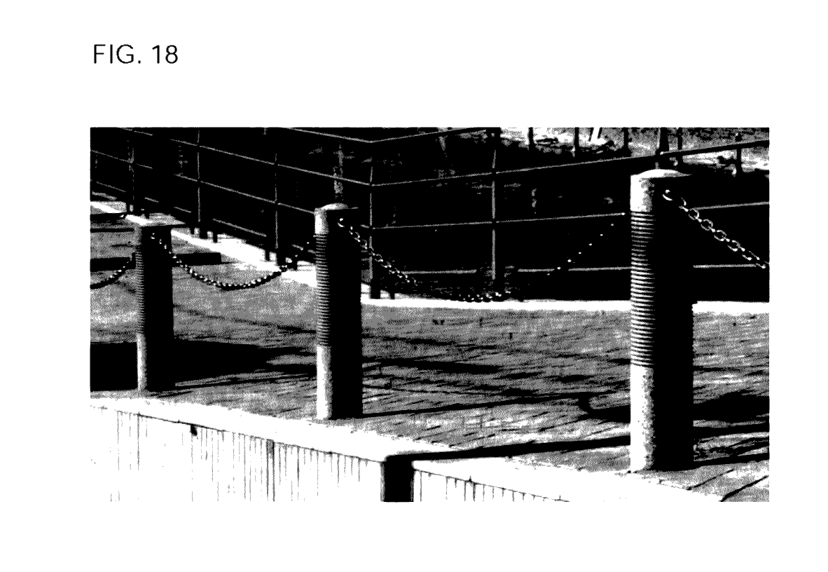

As shown on FIGS. 15, 16, 17 and 18, the decoration and function part (101) is formed on the outer circumference (101a) of the concrete pole (100) according to the shape of the decoration and function shaping part (23) of the first and second inner moulds (21)(22). If the decoration and function shaping part (23) has no particular shape, the outer surface of the concrete pole (100) has no particular shape accordingly. Or various shapes, which include engraving and emboss (101b), circle, polygon, stripes arranged longitudinally with constant interval, specific designs requested by consumers or local governments to advertise or promote the location, are integrally formed of concrete thereby providing integral aesthetic feeling.

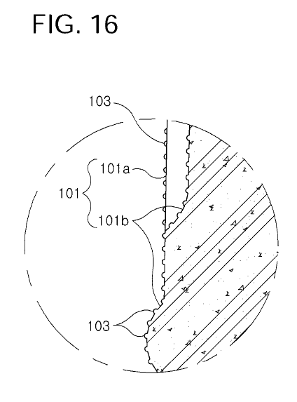

As shown on FIG. 16, many small protrusions (103) may be provided on the decoration and function part (101) in regular or irregular pattern to minimize contact area to prevent adherence of unwanted attachments.

In addition, grinding process may be applied after moulding the concrete pole to provide appearance of natural rock. Such grinding may be done to a degree so that inner surfaces of the grooves of the decoration and function part (101) formed with engravings and embosses (101b) are finished.

The grinding process includes water grinding, in which high pressure water jet is applied on the surface of the concrete pole to provide marble texture, shot blasting and sand blasting, in which high energy jet of air or sand is applied to the concrete pole surface to simulate natural weathering thereby providing natural granite texture.

Broken stone chips are mixed with the concrete, and when they are shaved by the grinding process, the texture and color of the chips like white, black or brown glass are exposed to provide natural rock appearance.

In addition, the grinded surface of the concrete pole (100) comprises fine rough protrusions which minimize contact area and maximize exposure to air so that adherence of unwanted attachments is prevented.

The fine protrusions (103) explained referring to FIG. 16 is formed during moulding. In contrast, the fine rough protrusions by post processing are formed after moulding by shot-blasting or sand-blasting. Choice of the method depends on manufacturing conditions and efficiency.

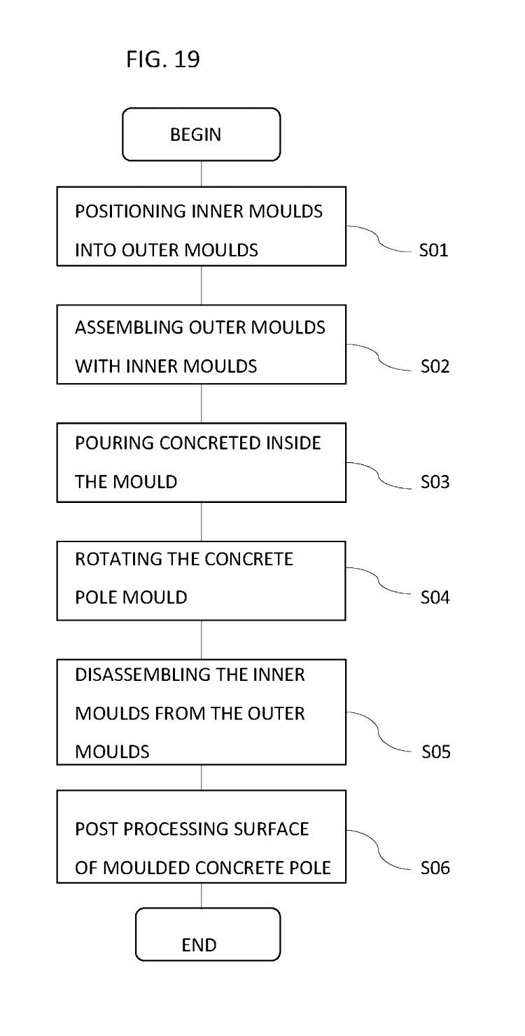

FIG. 19 shows a method of forming concrete poles using centrifugal force comprising Step (S01) of (a) positioning first and second inner moulds (21)(22) into first and second outer moulds (11)(12); wherein the first outer mould (11) and the second outer mould (12) have hollow inside and semi-circular shape, wherein each of the first outer mould (11) and the second outer mould (12) comprises an engaging jaw (13) that is formed longitudinally along the length of each of the two separating ends of the first outer mould (11) and second outer mould (12), a plurality of engaging holes (14) formed on the engaging jaw (13), wherein the first outer mould (11) and the second outer mould (12) are assembled with bolts passing through the engaging holes (14); wherein the first inner mould (21) and the second inner mould (22) have hollow inside and semi-circular shape, wherein the first and second inner moulds (21)(22) are received inside of the first and second outer moulds (11)(12), respectively; wherein a decoration and function shaping part (23) is detachably attached on the inner circumference of each of the first and second inner moulds (21)(22); wherein the decoration and function shaping parts (23) are adapted to form a decoration and function part (101) on the outer circumference of a concrete pole (100) moulded by the mould device (1); Step (S02) of assembling the first and second outer moulds (11)(12) with the first and second inner moulds (21)(22), wherein the assembled first and second outer moulds (11)(12) and first and second inner moulds (21)(22) constitute a concrete pole mould device (1); Step (S03) of pouring concrete into inside of the concrete pole mould (1); Step (S04) of rotating the concrete pole mould (1); and Step (S05) of disassembling the first and second inner moulds (21)(22) from the first and second outer moulds (11)(12).

Step (S06) of post-processing the outer circumferential surface of the moulded concrete pole is performed to provide natural stone like appearance. The post-processing includes grinding and shot-blasting.

While the invention is described with particular embodiments and drawings, it will be apparent to those skilled in the art that various modifications and variations can be made in the devices and methods of the present disclosure without departing from the scope of the invention. It is intended that the specification and examples be considered as exemplary only.

1. A mould device for forming concrete poles using centrifugal force, wherein concrete poured inside the mould device and the mould device is rotated at high speed, comprising:
(a) a first outer mould and a second outer mould that have hollow inside and semi-circular shape, wherein each of the first outer mould and the second outer mould comprises an engaging jaw that is formed longitudinally along the length of each of the two separating ends of the first outer mould and second outer mould, a plurality of engaging holes formed on the engaging jaw, wherein the first outer mold and the second outer mould are assembled with bolts passing through the engaging holes;
(b) a first inner mould and a second inner mould that have hollow inside and semi-circular shape, wherein the first and second inner moulds are received inside of the first and second outer moulds, respectively; wherein a decoration and function shaping part is detachably attached on the inner circumference of each of the first and second inner moulds; wherein the decoration and function shaping parts are adapted to form a decoration and function part on the outer circumference of a concrete pole moulded by the mould device; and
(c) a mould fixing and release device that fixes the first and second inner moulds inside the first and second outer moulds in the process of preparing moulding of the concrete pole, and releases the first and second inner moulds from the first and second outer moulds after moulding is complete.

2. The mould device of claim 1, wherein the mould fixing and releasing device comprises one or more through slots formed on each of the first and second outer moulds extending along the circumference of the circle viewed from side when the first and second outer moulds are assembled, threaded rods formed on the outer circumferences of the first and second inner moulds at positions corresponding to the through slots and protrude a length that pass beyond the through slots, and nuts engaging with threaded rods.

3. The mould device of claim 1, wherein the mould fixing and release device comprises through slots formed on each of the first and second outer moulds extending along the circumference of the circle viewed from side when the first and second outer moulds are assembled, and bent assembly rods formed on the outer circumferences of the first and second inner moulds at positions corresponding to the through slots, wherein the bent assembly rods are bent in L shape and reversed L shape to have a knock portion at its end and a fixing groove surrounded by the bent portion, wherein the bent assembly rods pass through the through slots, wherein the through slot is formed longer than the size of the end of the bent assembly rod to enable passing of the bent assembly rod.

4. The mould device of claim 1, wherein the decoration and function shaping part comprises engraved and embossed parts, the shape of which comprise lattice, elongated longitudinal grooves, rings, irregular forms, or geometrical figures.

5. The mould device of claim 1, wherein the first and second inner moulds comprise a plurality of inner mould segments that divide the inner moulds longitudinally or horizontally, and end inner mould segments;
wherein each of the inner mould segments comprises a first engaging jaw formed on its one end, wherein the first engaging jaw has a protrusion, the surface of which directs upward with reference to the centerline of the side of the segment, and a second engaging jaw formed on its other end, the surface of which directs downward with reference to the centerline of the side of the segment, and thereby the first engaging jaw and the second engaging jaw correspond with each other, wherein the plurality of the inner mould segments are received inside the first and second outer moulds with their first engaging jaws and second engaging jaws engaged with each other in series; and,
wherein the end inner mould segments comprise first, second engaging jaws that correspond to the first, second engaging jaws of the inner mould segments located far outside among the plurality of the inner mould segments received in the first and second outer moulds.

6. The mould device of claim 1, wherein the engaging jaws provided at the two sides of the first outer mould comprise engaging grooves, and the corresponding engaging jaws of the second outer mould comprise engaging protrusions, which are received in the engaging grooves, wherein a sealing ring is provided in the engaging groove and compressed by the engaging protrusion.

7. The mould device of claim 1, wherein an access opening forming part of a predetermined size is provided longitudinally on the inner circumference of either of the first and second inner moulds thereby installing an access opening.

8. A method of forming concrete poles using centrifugal force comprising steps of:
(a) positioning first and second inner moulds into first and second outer moulds;
wherein the first outer mould, and the second outer mould have hollow inside and semi-circular shape, wherein each of the first outer mould and the second outer mould comprises an engaging jaw that is formed longitudinally along the length of each of the two separating ends of the first outer mould and second outer mould, a plurality of engaging holes formed on the engaging jaw, wherein the first outer mold and the second outer mould are assembled with bolts passing through the engaging holes;
wherein the first inner mould and the second inner mould that have hollow inside and semi-circular shape, wherein the first and second inner moulds are received inside of the first and second outer moulds, respectively; wherein a decoration and function shaping part is detachably attached on the inner circumference of each of the first and second inner moulds; wherein the decoration and function shaping parts are adapted to form a decoration and function part on the outer circumference of a concrete pole moulded by the mould device; and
(b) assembling the first and second outer moulds with the first and second inner moulds, wherein the assembled first and second outer moulds and first and second inner moulds constitute a concrete pole mould;
(c) pouring concrete into inside of the concrete pole mould;
(d) rotating the concrete pole mould; and
(e) disassembling the first and second inner moulds from the first and second outer moulds.

9. The method of claim 8, wherein the mould fixing and release device comprises through slots formed on each of the first and second outer moulds extending along the circumference of the circle viewed from side when the first and second outer moulds are assembled, and bent assembly rods formed on the outer circumferences of the first and second inner moulds at positions corresponding to the through slots, wherein the bent assembly rods are bent in L shape and reversed L shape to have a knock portion at its end and a fixing groove surrounded by the bent portion, wherein the bent assembly rods pass through the through slots, wherein the through slot is formed longer than the size of the end of the bent assembly rod to enable passing of the bent assembly rod;
wherein at the step of rotating the concrete pole mould, initially the first and second outer moulds are rotated but the first and second inner moulds, which have not been fixed to the first and second outer moulds yet, are not rotated, and then one end of the rotating through slot is inserted into the fixing groove of the bent assembly rod thereby being fixed to it, and then further rotation of the first and second outer moulds rotates the first and second inner moulds.

10. The method of claim 9, wherein at the step of disassembling the first and second inner moulds from the first and second outer moulds, the knock portion of the bent assembly rod is hit in the reverse rotation direction with a hitting tool to cause movement of the bent assembly rod in the through slot thereby causing movement of the first and second inner moulds from which the bent assembly rods protrude.

11. The method of claim 8, wherein the mould fixing and release device comprises one or more through slots formed on each of the first and second outer moulds extending along the circumference of the circle viewed from side when the first and second outer moulds are assembled; a threaded rod formed on the outer circumference of the first inner mould at a position corresponding to the through slot and protrudes a length that passes beyond the through slot; a nut engaging with the threaded rod; and a bent assembly rod formed on the outer circumference of the second inner mould at a position corresponding to the through slot;
wherein the bent assembly rod is bent in L shape to have a knock portion at its end and a fixing groove surrounded by the bent portion, wherein the bent assembly rod passes through the through slot, which is formed longer than the size of the end of the bent assembly rod to enable passing of the bent assembly rod;
wherein at the step of rotating the concrete pole mould, the first and second outer moulds start to rotate while the first and second inner moulds remain stationary thereby causing one end of the through slot formed on the second outer mould to be inserted and fixed into the fixing groove of the bent assembly rod.

12. The method of claim 11, wherein at the step of disassembling the first and second inner moulds from the first and second outer moulds, the knock portion of the bent assembly rod formed on the second inner mould is hit in the reverse rotation direction with a hitting tool to cause movement of the bent assembly rod in the through slot thereby causing movement of the second inner mould along the through slot.

13. The method of claim 8, further comprising grinding the outer circumferential surface of the moulded concrete pole.

14. The method of claim 8, further comprising shot blasting the outer circumferential surface of the moulded concrete pole. A concrete pole made by a method of forming concrete poles using centrifugal force comprising steps of:
(a) positioning first and second inner moulds into first and second outer moulds;
wherein the first outer mould and the second outer mould have hollow inside and semi-circular shape, wherein each of the first outer mould and the second outer mould comprises an engaging jaw that is formed longitudinally along the length of each of the two separating ends of the first outer mould and second outer mould, a plurality of engaging holes formed on the engaging jaw, wherein the first outer mold and the second outer mould are assembled with bolts passing through the engaging holes;
wherein the first inner mould and the second inner mould that have hollow inside and semi-circular shape, wherein the first and second inner moulds are received inside of the first and second outer moulds, respectively; wherein a decoration and function shaping part is detachably attached on the inner circumference of each of the first and second inner moulds; wherein the decoration and function shaping parts are adapted to form a decoration and function part on the outer circumference of a concrete pole moulded by the mould device; and
(b) assembling the first and second outer moulds with the first and second inner moulds, wherein the assembled first and second outer moulds and first and second inner moulds constitute a concrete pole mould;
(c) pouring concrete into inside of the concrete pole mould;
(d) rotating the concrete pole mould; and
(e) disassembling the first and second inner moulds from the first and second outer moulds.
